(19) United States
(12) Patent Application Publication
(10) Pub. No.: US 2019/0049801 A1
(43) Pub. Date: Feb. 14, 2019

(54) TRANSFLECTIVE LIQUID CRYSTAL DISPLAY DEVICE

(71) Applicant: Shenzhen China Star Optoeletronics Semiconductor Display Technology Co., Ltd., Shenzhen City (CN)

(72) Inventors: Minggang Liu, Shenzhen City (CN); Yunglun Lin, Shenzhen City (CN)

(21) Appl. No.: 15/578,250

(22) PCT Filed: Nov. 15, 2017
(86) PCT No.: PCT/CN2017/110981

§ 371 Date: Nov. 30, 2017

(30) Foreign Application Priority Data
Aug. 10, 2017 (CN) 201710681537.2

(51) Int. Cl. G02F 1/1362; G02F 1/1368; G02F 1/1339; G02F 1/1343; G02F 1/1335

(52) U.S. Cl. CPC G02F 1/136209; G02F 1/1368; G02F 1/13394; G02F 1/13439; G02F 1/133553; G02F 2001/133302; G02F 1/133514; G02F 2201/123; G02F 2001/133531; G02F 2201/121; G02F 1/133528

(57) ABSTRACT

The present invention provides a transflective liquid crystal display. In the transflective liquid crystal display of the present invention, both the black matrix and the spacers are fabricated on the thin film transistor array substrate, and the reflective layer is disposed on the black matrix so that the reflective region does not occupy the area of the transmissive region, the present invention can keep the light transmittance of the backlight source the same and enhance the display brightness with using the ambient light, compared with the conventional transmissive liquid crystal display. The invention also utilizes the thickness of the black matrix to control the thickness of the liquid crystal cell in the reflective region and avoids making additional insulating layer under the reflective layer to control the thickness of the liquid crystal cell so as to effectively save the manufacturing process. In addition, by forming the black matrix and the spacers integrally, the manufacturing process can be further saved and the production cost can be reduced.

### BACKGROUND OF THE INVENTION

### Field of Invention

The present invention relates to the field of liquid crystal display, and more particularly to a transflective liquid crystal display device.

### Description of Prior Art

With the improvement of display technology, flat panel display devices such as the liquid crystal display (LCD) has been widely used in various consumer electronic products such as mobile phones, televisions, personal digital assistants, digital cameras, notebooks, and desktop with high quality, power saving, thin body and wide application range, and has become the mainstream of the display devices.

Most of the liquid crystal display devices on the market are backlight type liquid crystal displays, each of which includes a liquid crystal display panel and a backlight module. The working principle of the liquid crystal display panel is to place liquid crystal molecules between a thin film transistor array substrate (TFT array substrate) and a color filter substrate (CF substrate), and a driving voltage is applied on the two substrate for controlling the rotating direction of the liquid crystal molecules, to produce an image by refracting the light from the backlight module.

Generally, the liquid crystal display panel is composed of a color filter (CF) substrate, a thin film transistor (TFT) substrate, a liquid crystal (LC) sandwiched between the CF substrate and the TFT substrate, and a sealant. The forming process generally includes: an array process (thin film, yellow light, etching and stripping) at front end of line, a cell process (bonding of the TFT substrate and the CF substrate) at middle end of line, and a module assembly process (lamination of the driver IC and printed circuit board) at back end of line. Among them, the array process at front end of line is mainly the formation of TFT substrate in order to control the movement of liquid crystal molecules; the cell process at middle end of line is mainly for adding the liquid crystal into the TFT substrate and the CF substrate; the module assembly process at back end of line is mainly for integrating the driven IC and the printed circuit board, to drive the liquid crystal molecules to rotate for displaying images.

Liquid crystal displays (LCDs) can be classified into three basic types, according to reflective method: Transmissive, Reflective and Transflective. The transflective liquid crystal display (LCD) achieves transmissive display via a backlight source. The advantage of the transmissive LCD is that it can maintain a good display performance under normal light and low light, but not easily recognizable the display content in the outdoor sunlight. The reflective liquid crystal display does not need an external light source, but uses light around the environment. Therefore, the reflective liquid crystal display has a good display performance in the environment with sufficient outside light, but the display content is not easy to be recognized under the environment with insufficient light. The transflective liquid crystal display combines the advantages of both transmissive and reflective, the transflective liquid crystal display can also use the backlight source and the ambient outside light to display, the pixel area can be divided into reflective regions and transmissive regions. The reflective regions are provided with a reflection layer for reflecting the ambient light of the outside and the transmissive regions are provided with transparent pixel electrodes for penetrating the backlight source. As the transflective LCD can simultaneously use the backlight source and the outside ambient light, so its applications have gradually attracted the attention of all parties. However, the conventional transflective LCDs generally make the CFs, the black matrix, and the spacers on the CF substrate of the LCD. Therefore, it is necessary to make an insulation layer under the reflective layer of the TFT array substrate to achieve the purpose of controlling the thickness of the liquid crystal cell in the reflective area. The design and fabrication of the insulating layer are quite complicated and difficult. Furthermore, since the reflective regions occupy the transmissive regions of the original pixel area, the light transmittance of the backlight source is seriously reduced.

### SUMMARY OF THE INVENTION

Therefore, an object of the present invention is to provide a transflective liquid crystal display which can further enhance the display brightness by using the ambient light while maintaining the original light transmittance of the backlight source to achieve excellent display performance in various light environments, with simple manufacturing process and low production costs.

In order to achieve the object, the present invention provides a transflective liquid crystal display, which comprises an upper substrate and a lower substrate disposed opposite to each other, a backlight source disposed under the lower substrate, and a liquid crystal layer disposed between the upper substrate and the lower substrate.

The lower substrate comprises a first base substrate, a TFT device layer disposed on the first base substrate, a black matrix and pixel electrodes disposed on the TFT device layer, spacers disposed on the black matrix, and a reflective layer covering on a region of the black matrix surface other than the spacers.

Within a horizontal plane parallel to the upper substrate and the lower substrate, a region corresponding to the reflective layer is a reflective region, and a region corresponding to the pixel electrode is a transmissive region.

The reflective layer is conductive and connected to the pixel electrodes.

The transflective liquid crystal display of the present invention further comprises an upper polarizer attached to a side of the upper substrate away from the liquid crystal layer and a lower polarizer attached to a side of the lower substrate away from the liquid crystal layer.

The polarization directions of the upper polarizer and the lower polarizer are the same.

A thickness of the liquid crystal layer in the reflective region is half of a thickness of the liquid crystal layer in the transmissive region.

The black matrix and spacers are made of the same material integrally.

The material of the reflective layer is selected from the group consisting of aluminum and silver.

The upper substrate comprises a second base substrate, a color photoresist layer disposed on the second base substrate, and common electrodes disposed on the color photoresist layer.

Both the first base substrate and the second base substrate are glass substrates, the pixel electrodes are transparent electrodes.

The material of the pixel electrodes is selected from the group consisting of a transparent conductive metal oxide.

The present invention further provides a transflective liquid crystal display, which comprises an upper substrate and a lower substrate disposed opposite to each other, a backlight source disposed under the lower substrate, and a liquid crystal layer disposed between the upper substrate and the lower substrate.

The lower substrate comprises a first base substrate, a TFT device layer disposed on the first base substrate, a black matrix and pixel electrodes disposed on the TFT device layer, spacers disposed on the black matrix, and a reflective layer covering on a region of the black matrix surface other than the spacers.

Within a horizontal plane parallel to the upper substrate and the lower substrate, a region corresponding to the reflective layer is a reflective region, and a region corresponding to the pixel electrode is a transmissive region.

Wherein the reflective layer is conductive and connected to the pixel electrodes.

The transflective liquid crystal display of the present invention further comprises an upper polarizer attached to a side of the upper substrate away from the liquid crystal layer and a lower polarizer attached to a side of the lower substrate away from the liquid crystal layer.

Wherein the polarization directions of the upper polarizer and the lower polarizer are the same.

Wherein a thickness of the liquid crystal layer in the reflective region is half of a thickness of the liquid crystal layer in the transmissive region.

Wherein the black matrix and spacers are made of the same material integrally.

The beneficial effects of the present invention are: in the transflective liquid crystal display of the present invention, both the black matrix and the spacers are fabricated on the thin film transistor array substrate, and the reflective layer is disposed on the black matrix so that the reflective region does not occupy the area of the transmissive region, the present invention can keep the light transmittance of the backlight source the same and enhance the display brightness with using the ambient light, compared with the conventional transmissive liquid crystal display. The invention also utilizes the thickness of the black matrix to control the thickness of the liquid crystal cell in the reflective region and avoids making additional insulating layer under the reflective layer to control the thickness of the liquid crystal cell so as to effectively save the manufacturing process. In addition, by forming the black matrix and the spacers integrally, the manufacturing process can be further saved and the production cost can be reduced.

For further understanding of the features and technical contents of the present invention, reference should be made to the following detailed description and accompanying drawings of the present invention. However, the drawings are for reference only and are not intended to limit the present invention.

### BRIEF DESCRIPTION OF THE DRAWINGS

The technical solutions of the present invention and other beneficial effects will be apparent from the following detailed description of specific embodiments of the present invention with reference to the accompanying drawings.

In drawings:

FIG. 1 is an illustrative cross-sectional view of a transflective liquid crystal display according to the present invention.

FIG. 2 is an illustrative top view of the transflective liquid crystal display according to the present invention.

### DETAILED DESCRIPTION OF THE PREFERRED EMBODIMENTS

The technical means and the effects thereof will be further described with reference to the preferred embodiments of the present invention and their accompanying drawings.

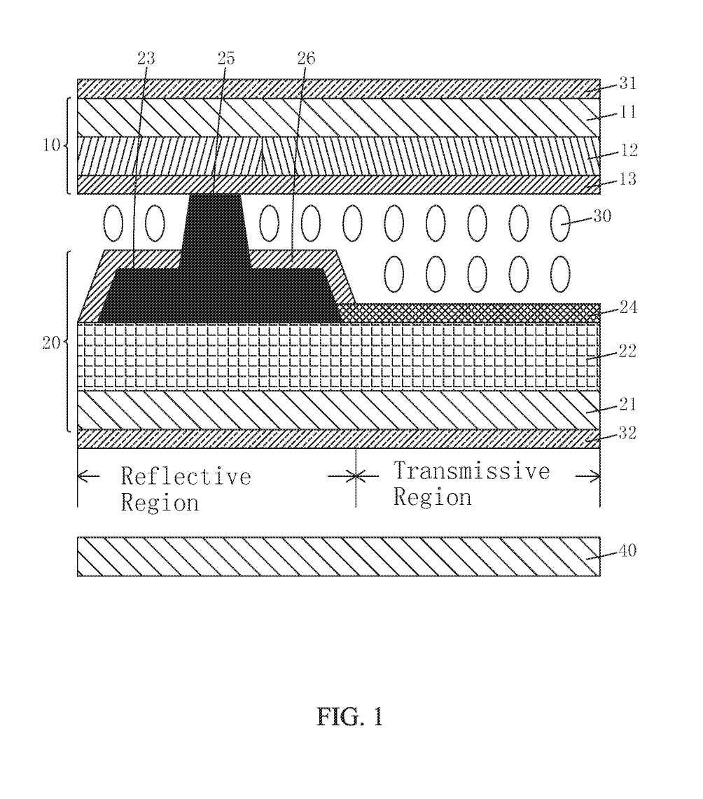

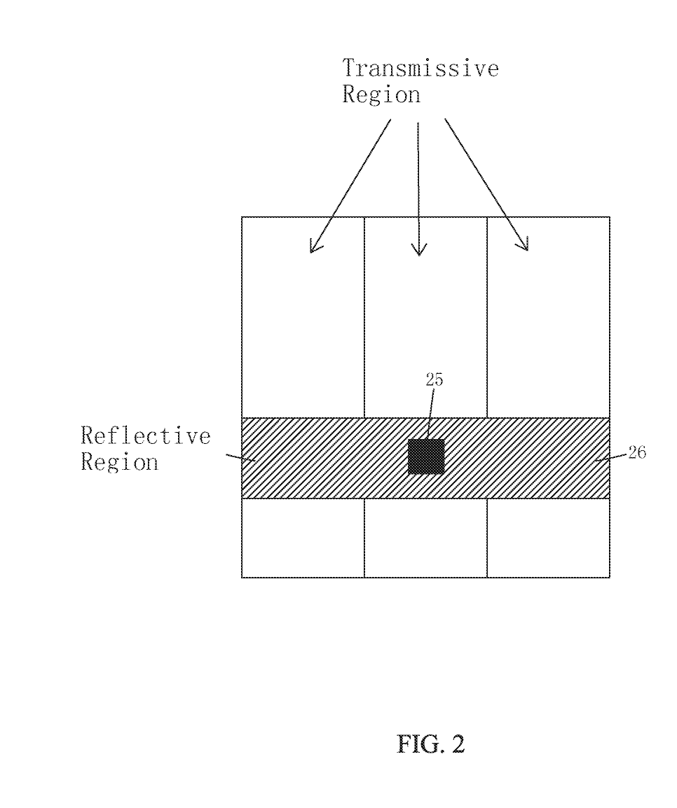

Please refer to FIGS. 1-2, the present invention provides a transflective liquid crystal display, which comprises an upper substrate 10 and a lower substrate 20 disposed opposite to each other, a backlight source 40 disposed under the lower substrate 20, and a liquid crystal layer 30 disposed between the upper substrate 10 and the lower substrate 20.

The lower substrate 20 comprises a first base substrate 21, a TFT device layer 22 disposed on the first base substrate 21, a black matrix 23 and pixel electrodes 24 disposed on the TFT device layer 22, spacers 25 disposed on the black matrix 23, and a reflective layer 26 covering on a region of the black matrix 23 surface other than the spacers 25.

Within a horizontal plane parallel to the upper substrate 10 and the lower substrate 20, a region corresponding to the reflective layer 26 is a reflective region, and a region corresponding to the pixel electrode 24 is a transmissive region.

Specifically, the reflective layer 26 is conductive and connected to the pixel electrodes 24, so that the liquid crystal layer 30 in the reflective region and the transmissive region can be controlled synchronously.

In the transflective liquid crystal display of the present invention, the reflective layer 26 is disposed on the black matrix 23 so as not to occupy the area of the transmissive region. Compared with the conventional transmissive liquid crystal display, the light transmittance of the backlight source 40 is kept the same. In addition, the present invention also utilizes the ambient light of the environment to enhance the display brightness, so that the transflective liquid crystal display of the present invention can achieve excellent display performance in various light environments.

A thickness of the liquid crystal layer 30 in the reflective region is half of a thickness of the liquid crystal layer 30 in the transmissive region.

Specifically, when an optical path difference between o light and e light of the backlight source passing through the liquid crystal layer 30 from the transmissive region is λ/2, an optical path difference between o light of and e light of the ambient light passing through the liquid crystal layer 30 from the reflective region to the reflective layer 26 is λ/4, and the optical path difference between o light and e light of the ambient light reflected from the reflective layer 26 by passing through the liquid crystal layer 30 is also λ/4, so a total optical path difference between o light and e light of the ambient light from entering liquid crystal layer 30 to be reflected from the liquid crystal layer 30 is λ/2, which is the same as the optical path difference between o light and e light of the backlight source passing through the liquid crystal layer 30 from the transmissive region. Hence, when the polarization directions of the ambient light and the backlight light remain the same before entering the liquid crystal layer 30, the polarization direction of the ambient light enters and reflects from the liquid crystal layer 30 and the polarization direction of the backlight source passing through the liquid crystal layer 30 from the transmissive region are the same.

Specifically, the thickness of the liquid crystal layer 30 in the reflective region can be achieved by controlling the thickness of the black matrix 23.

Specifically, the transflective liquid crystal display of the present invention further comprises an upper polarizer 31 attached to a side of the upper substrate 10 away from the liquid crystal layer 30 and a lower polarizer 32 attached to a side of the lower substrate 20 away from the liquid crystal layer 30. The polarization directions of the upper polarizer 31 and the lower polarizer 32 are the same, which is good to keep the reflective region and the transmissive region with bright state and dark state at the same time, the specific principle is:

In the transmissive region, when the polarization direction of light of the backlight source 40 passes through the liquid crystal layer 30 and rotates by zero degree, the light of the backlight source 40 orderly passes through the upper polarizer 31 and the lower polarizer 32 with the same polarization direction, and the transmissive region is displayed in a bright state. In the reflection region, when the polarization direction of ambient light enters and reflects from the liquid crystal layer 30 from the side of the upper substrate 10, and rotates by zero degree, the ambient light passes through the upper polarizer 31 two times, and the reflection region also shows a bright state.

In the transmissive region, when the polarization direction of light of the backlight source 40 passes through the liquid crystal layer 30 and rotates by 90 degrees, the light of the backlight source 40 orderly passes through the upper polarizer 31 and the lower polarizer 32 with the same polarization direction, and the transmissive region is displayed in a dark state. In the reflection region, when the polarization direction of ambient light enters and reflects from the liquid crystal layer 30 from the side of the upper substrate 10, and rotates by 90 degrees, the ambient light passes through the upper polarizer 31 two times, and the reflection region also shows a dark state.

Specifically, the black matrix 23 and spacers 25 are made of the same material integrally.

Specifically, the material of the reflective layer 26 is selected from the group consisting of aluminum and silver.

Specifically, the upper substrate 10 comprises a second base substrate 11, a color photoresist layer 12 disposed on the second base substrate 11, and common electrodes 13 disposed on the color photoresist layer 12.

Specifically, both the first base substrate 21 and the second base substrate 11 are glass substrates, the pixel electrodes 24 are transparent electrodes.

Specifically, the material of the pixel electrodes 24 is selected from the group consisting of a transparent conductive metal oxide, preferably be Indium Tin Oxide (ITO).

As mentioned above, in the transflective liquid crystal display of the present invention, both the black matrix and the spacers are fabricated on the thin film transistor array substrate, and the reflective layer is disposed on the black matrix so that the reflective region does not occupy the area of the transmissive region, the present invention can keep the light transmittance of the backlight source the same and enhance the display brightness with using the ambient light, compared with the conventional transmissive liquid crystal display. The invention also utilizes the thickness of the black matrix to control the thickness of the liquid crystal cell in the reflective region and avoids making additional insulating layer under the reflective layer to control the thickness of the liquid crystal cell so as to effectively save the manufacturing process. In addition, by forming the black matrix and the spacers integrally, the manufacturing process can be further saved and the production cost can be reduced.

As mentioned above, those of ordinary skill in the art, without departing from the spirit and scope of the present invention, can make various kinds of modifications and variations to the present invention. Therefore, all such modifications and variations are intended to be included in the protection scope of the appended claims of the present invention.

What is claimed is:

1. A transflective liquid crystal display, comprising an upper substrate and a lower substrate disposed opposite to each other, a backlight source disposed under the lower substrate, and a liquid crystal layer disposed between the upper substrate and the lower substrate;
the lower substrate comprising a first base substrate, a TFT device layer disposed on the first base substrate, a black matrix and pixel electrodes disposed on the TFT device layer, spacers disposed on the black matrix, and a reflective layer covering on a region of the black matrix surface other than the spacers;
within a horizontal plane parallel to the upper substrate and the lower substrate, a region corresponding to the reflective layer being a reflective region, and a region corresponding to the pixel electrode being a transmissive region.

2. The transflective liquid crystal display according to claim 1, wherein the reflective layer is conductive and connected to the pixel electrodes.

3. The transflective liquid crystal display according to claim 1, further comprising an upper polarizer attached to a side of the upper substrate away from the liquid crystal layer and a lower polarizer attached to a side of the lower substrate away from the liquid crystal layer.

4. The transflective liquid crystal display according to claim 3, wherein the polarization directions of the upper polarizer and the lower polarizer are the same.

5. The transflective liquid crystal display according to claim 1, wherein a thickness of the liquid crystal layer in the reflective region is half of a thickness of the liquid crystal layer in the transmissive region.

6. The transflective liquid crystal display according to claim 1, wherein the black matrix and spacers are made of the same material integrally.

7. The transflective liquid crystal display according to claim 1, wherein the material of the reflective layer is selected from the group consisting of aluminum and silver.

8. The transflective liquid crystal display according to claim 1, wherein the upper substrate comprises a second base substrate, a color photoresist layer disposed on the second base substrate, and common electrodes disposed on the color photoresist layer.

9. The transflective liquid crystal display according to claim 1, wherein both the first base substrate and the second base substrate are glass substrates, the pixel electrodes are transparent electrodes.

10. The transflective liquid crystal display according to claim 9, wherein the material of the pixel electrodes is selected from the group consisting of a transparent conductive metal oxide.

11. A transflective liquid crystal display, comprising an upper substrate and a lower substrate disposed opposite to each other, a backlight source disposed under the lower substrate, and a liquid crystal layer disposed between the upper substrate and the lower substrate;
the lower substrate comprising a first base substrate, a TFT device layer disposed on the first base substrate, a black matrix and pixel electrodes disposed on the TFT device layer, spacers disposed on the black matrix, and a reflective layer covering on a region of the black matrix surface other than the spacers;
within a horizontal plane parallel to the upper substrate and the lower substrate, a region corresponding to the reflective layer being a reflective region, and a region corresponding to the pixel electrode being a transmissive region;
wherein the reflective layer is conductive and connected to the pixel electrodes;
further comprising an upper polarizer attached to a side of the upper substrate away from the liquid crystal layer and a lower polarizer attached to a side of the lower substrate away from the liquid crystal layer;
wherein the polarization directions of the upper polarizer and the lower polarizer are the same;
wherein a thickness of the liquid crystal layer in the reflective region is half of a thickness of the liquid crystal layer in the transmissive region;
wherein the black matrix and spacers are made of the same material integrally.

12. The transflective liquid crystal display according to claim 11, wherein the material of the reflective layer is selected from the group consisting of aluminum and silver.

13. The transflective liquid crystal display according to claim 11, wherein the upper substrate comprises a second base substrate, a color photoresist layer disposed on the second base substrate, and common electrodes disposed on the color photoresist layer.

14. The transflective liquid crystal display according to claim 11, wherein both the first base substrate and the second base substrate are glass substrates, the pixel electrodes are transparent electrodes.

15. The transflective liquid crystal display according to claim 14, wherein the material of the pixel electrodes is selected from the group consisting of a transparent conductive metal oxide.
